(19) United States
(12) Patent Application Publication
(10) Pub. No.: US 2003/0003367 A1
(43) Pub. Date: Jan. 2, 2003

(54) Lithium battery and method for the preparation thereof

(76) Inventors: Kwon-Sun Roh, Cheonan-si (KR); Dong-Joon Ihm, Seoul (KR); Jon-Ha Lee, Cheonan-si (KR)

Correspondence Address: David A. Einhorn, Esq., Anderson Kill & Olick, P.C., 1251 Avenue of the Americas, New York, NY, 10020, US

(21) Appl. No.: 10/143,352

(22) Filed: May 9, 2002

(30) Foreign Application Priority Data
Jun. 30, 2001 (KR) 2001-38809

(51) Int. Cl. H01M 10/40; H01M 10/04

(52) U.S. Cl. 429/300; 429/303; 29/623.1

(57) ABSTRACT

The present invention provides a lithium battery having improved performance properties and no risk of electrolyte leakage which comprises both a liquid electrolyte and a gel-type electrolyte.

### FIELD OF THE INVENTION

The present invention relates to a lithium battery which comprises both a liquid electrolyte and a gel-type electrolyte, said battery exhibiting improved performance properties and having no risk of electrolyte leakage.

### BACKGROUND OF THE INVENTION

Lithium secondary batteries have a common structural feature that includes a cathode, an anode, an organic electrolyte and a lithium ion-permeable separator disposed between the electrodes. The electrical energy is generated by redox reactions occurring on the electrodes. The lithium secondary batteries are generally of two types depending on the kind of electrolyte used: a lithium ion battery which employs a liquid eletrolyte; and a lithium ion polymer battery which comprises a solid polymer electrolyte.

A lithium ion polymer battery has advantages in that it is free from problems of electrolyte leakage and that it can be manufactured in many forms, e.g., an angular-shape.

However, in spite of such merits, a lithium ion polymer battery generally exhibits lower ionic conductivity as compared with a lithium ion battery, and performance properties thereof are often unsatisfactory.

Accordingly, recent polymer battery researches have focused their attention on a gel-type polymer electrolyte which is capable of providing improved ionic conductivity as compared with a solid polymer electrolyte. A gel-type polymer electrolyte is generally a solution containing a gel-forming polymer and an ionic salt, wherein the ion mobility is enhanced.

Various gel-type polymer electrolyte-containing lithium polymer batteries are disclosed in U.S. Pat. Nos. 5,639,573 and 5,665,265, and Japanese Patent Publication Nos. 99-283672 and 99-283673.

However, such a gel-type polymer electrolyte tends to clog pores of electrode and separator sheets, and still exhibits substantially unsatisfactory performance properties as compared with a liquid electrolyte.

### SUMMARY OF THE INVENTION

Accordingly, it is an object of the present invention to provide a lithium battery having improved performance characteristics and no risk of electrolyte leakage.

In accordance with one aspect of the present invention, there is provided a lithium battery comprising a battery case, a liquid electrolyte, a gel-type electrolyte and an electrode stack sealed in the battery case, the stack being made of a cathode, an anode, and a separator interposed between the cathode and the anode, wherein the liquid electrolyte is substantially confined in an inner part of the electrode stack, and the gel-type electrolyte, substantially in an outer part of the electrode stack.

### BRIEF DESCRIPTION OF THE DRAWINGS

The above and other objects and features of the present invention will become apparent from the following description of the invention, when taken in conjunction with the accompanying drawings, which respectively show:

FIG. 1: a schematic diagram of a lithium battery prepared in accordance with one embodiment of the present invention, which exhibits that a gel polymer is distributed on the outer portion of the electrode stack;

FIG. 2: variations of regular discharge capacity(%) of the batteries obtained in Examples and Comparative Examples as function of discharge rate(C);

FIG. 3: variations of voltage value(V) at −10° C. and 1C. discharge rate of the batteries obtained in Examples and Comparative Examples as function of reduced capacity(%); and

FIG. 4: variations of regular discharge capacity(%) of the batteries obtained in Examples and Comparative Examples as function of the cycle number.

### DETAILED DESCRIPTION OF THE INVENTION

The battery in accordance with the present invention is characterized in that a liquid electrolyte is substantially localized in an inner part of an electrode stack, while a gel-type electrolyte is substantially filled in an outer part of the electrode stack, acting as a barrier to prevent the liquid electrolyte from permeating therethrough.

The electrode stack generally consists of a cathode, an anode and a separator interposed between the cathode and the anode, wherein sizes of the constituents are different, i.e., the separator (e.g.: width 59 mm)> the anode (e.g.: width 57 mm)> the cathode (e.g.: width 55 mm). In this specification, the term “an inner part of the electrode stack” means a region in which the cathode and the anode are facing each other and charge/discharge takes place. In addition, the term “an outer part of the electrode stack” means a region excluding the inner side thereof defined above, i.e., open upper and lower end portions of the stack, specifically anode parts (corresponding to, e.g., 1 mm in the respective upper and lower end) and separator parts (corresponding to, e.g., 2 mm in the respective upper and lower end) extended from two ends of the cathode

Such an electrode stack is wound or folded, and used to prepare the inventive battery in accordance with a method which comprises: encasing the electrode stack in a case having an inlet; evacuating the case and introducing the liquid electrolyte; introducing the gel-type electrolyte containing a polymer or an in situ polymerizable monomer; optionally conducting in situ polymerization of the monomer; and sealing the inlet.

The liquid electrolyte which is used in the present invention may comprise an organic solvent and a lithium salt; and the gel-type electrolyte may comprise an organic solvent, a lithium salt and a polymer. Here, the polymer may be a polymer derived by carrying out in situ polymerization of monomers within the battery case.

Exemplary lithium salts that may be used in the present invention are LiClO₄, LiBF₄, LiPF₆, LiCF₃SO₃, LiN(CF₃SO₂)₂ and a mixture thereof. The lithium salt may be present at a concentration in the range of 0.5 to 2.0M in both the liquid and gel-type electrolytes. When the concentration of the salt is less than 0.5M, the capacity may become poor; and when it is more than 2.0M, the cycle life may become poor.

Representative examples of the organic solvent that may be used in the present invention include propylene carbonate, ethylene carbonate, diethyl carbonate, dimethyl carbonate, ethylmethyl carbonate, dipropyl carbonate, dimethyl sulfoxide, acetonitrile, dimethoxyethane, diethoxyethane, vinylene carbonate, gamma-butyrolactone, ethylene sulfite, propylene sulfite and tetrahydrofuran.

The in situ polymerizable monomer that may be used in the present invention may be of any type which is capable of forming a gellationable polymer by polymerization. Representative examples thereof include epoxide-based monomers and acryl-based monomers, among which 3,4-epoxycyclohexylmethyl-3′, 4′-epoxycyclohexanecarboxylate, butanediol diglycidylether, propyleneglycol diglycidylether, triethyleneglycol dimethacrylate and ethyleneglycol dimethacrylate are preferably used in the present invention.

The polymer that may be used in the present invention may be of any type which is capable of dissolving in the used solvent to form a gel. Representative examples thereof include polyvinylidene fluoride, polyethylene oxide, poly(vinylidene fluoride/hexafluoropropylene), polyacrylonitrile, polymethylmethacrylate, polystyrene, polytetrafluoroethylene, epoxide-based resins and acryl-based resins.

The inventive gel-type electrolyte may comprise such a polymer in an amount ranging from 6 to 30% by weight. When the amount of the polymer is less than 6% by weight, sufficient gelation cannot be achieved; and when it is more than 30% by weight, the gel-type electrolyte becomes too viscous.

In accordance with the present invention, the volume ratio of the liquid electrolyte and the gel-type electrolyte is in the range of 1:0.1˜2, preferably 1:0.5˜1.5. When the ratio is less than 0.1, the risk of electrolyte leakage becomes significant; and when it is more than 2, the ionic conductivity becomes poor.

After the liquid and gel-type electrolytes are charged in specified manner, the battery case may be sealed, and in case a polymerizable monomer is used, an in situ polymerization may be conducted at a temperature of 30 to 100° C. for 1 to 48 hrs.

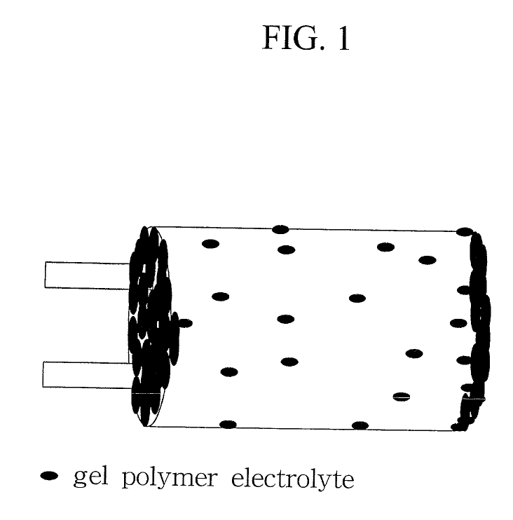

A lithium battery prepared by said method of the present invention comprises the liquid electrolyte as a primary element in an inner part of the electrode stack, thereby exhibiting improved performance properties including high ionic conductivity, and the gel-type electrolyte, in an outer part of the electrode stack to prevent the liquid electrolyte from leaking out. A schematic diagram of a lithium battery prepared in accordance with one embodiment of the present invention is shown in FIG. 1, which confirms that the gel-type electrolyte is distributed mainly on the upper and lower end portions of the electrode stack.

Typically, a cathode composition, i.e., a mixture of a cathode active material, a conducting agent, a binder and a solvent, may be coated directly on an aluminum current collector, or laminated in the form of a film on an aluminum current collector to form a cathode sheet.

The cathode active material may be lithium-containing metal oxides such as LiCoO₂, LiMnₓO₂ₓ, and LiNiₓMn₂₋ₓO₄ (wherein x is 1 or 2). The conducting agent may be carbon black; the binder may be vinylidene fluoride/hexafluoropropylene copolymers, polyvinylidene fluoride, polyacrylonitrile, polymethylmethacrylate or polytetrafluoroethylene; and the solvent may be N-methylpyrrolidone or acetone. The conducting agent, the binder and the solvent may be used in amounts ranging from 1 to 10 parts by weight, from 2 to 10 parts by weight, and from 30 to 100 parts by weight, respectively, based on 100 parts by weight of the cathode active material.

Also, an anode composition, i.e., a mixture of an anode active material, a conducting agent, a binder and a solvent, may be coated directly on a copper current collector, or laminated in the form of a film on a copper current collector to form an anode sheet.

Representative examples of the anode active material may include lithium metals, lithium alloys, carbon-based materials and graphite. The conducting agent, the binder and the solvent, which may be the same as those used in the cathode composition, may be used in amounts of below 10 parts by weight, ranging from 2 to 10 parts by weight, and from 30 to 100 parts by weight, respectively, based on 100 parts by weight of the anode active material. If necessary, a plasticizer may be further added to said cathode and anode compositions to form porous electrode sheets.

Further, the separator which is interposed between the cathode and the anode sheets may be of a microporous sheet made from, for example, a polymeric material such as polyethylene and polypropylene.

The following Examples and Comparative Examples are given for the purpose of illustration only, and are not intended to limit the scope of the invention.

### EXAMPLE 1

88 g of LiCoO₂, 6.8 g of carbon black, 5.2 g of polyvinylidene fluoride and 52.5 g of N-methylpyrrolidone were mixed to form a cathode composition, which was coated on an aluminum foil and dried to prepare a cathode sheet.

93.76 g of graphite, 6.24 g of polyvinylidene fluoride and 57.5 g of N-methylpyrrolidone were mixed to form an anode composition. This anode composition was coated on a copper foil and dried to prepare an anode sheet.

A polypropylene separator sheet was located between the cathode and the anode sheets to form an electrode stack. The electrode stack was wound in a jellyroll manner, placed in a container made from an aluminum-laminated film and then sealed by sealing machine.

100 g of 1M LiPF₆ in a 1:1:1 volume mixture of ethylene carbonate, dimethyl carbonate and diethyl carbonate(EC/DMC/DEC) was used as a liquid electrolyte. 10 g of 3,4-epoxycyclohexylmethyl-3′,4′epoxycyclohexanecarboxylate was dissolved into 90 g of 1M LiPF₆ in a 1:1:1 volume mixture of EC/DMC/DEC to form a gel-type electrolyte.

The sealed can was evacuated through the inlet, 1.5 cc of the liquid electrolyte was injected thereinto, and, then, 1.5 cc of the gel-type electrolyte was injected into the can kept at an ambient pressure. The inlet was closed by ball welding and heated at 65° C. for 4 hrs to allow the polymer precursor to undergo polymerization, to obtain a lithium battery.

### EXAMPLE 2

The procedure of Example 1 was repeated except that the liquid and gel-type electrolytes were used in amounts of 1.0 cc and 2.0 cc, respectively, to obtain a lithium battery.

### COMPARATIVE EXAMPLES 1 AND 2

The procedure of Example 1 was repeated except that only the liquid electrolyte was used in the respective amount of 3.0 cc and 2.2 cc, to obtain two comparative conventional lithium ion batteries.

### COMPARATIVE EXAMPLE 3

The procedure of Example 1 was repeated except that only the gel-type electrolyte was used in an amount of 3.0 cc, to obtain a conventional lithium ion polymer battery.

### COMPARATIVE EXAMPLE 4

The procedure of Example 1 was repeated except that the injection of both of the liquid and gel-type electrolytes was performed at an ambient pressure, to obtain a lithium battery. During the heat polymerization process, the liquid and gel-type electrolytes became mixed and distributed evenly in the electrode stack, and, thus, no gellation of the gel-type electrolyte occurred due to dilution of the polymerizable monomer.

Battery Performance Characteristics

Each of the lithium batteries obtained in Examples and Comparative Examples was unsealed, and a pressure of 500 kgf was applied to the electrode stacks to examine whether permeated electrolyte leaked out. The comparative batteries of Comparative Examples 1 and 2 showed leakage, while no leakage was observed for the battery obtained in Comparative Example 3, or for the batteries obtained in Examples 1 and 2.

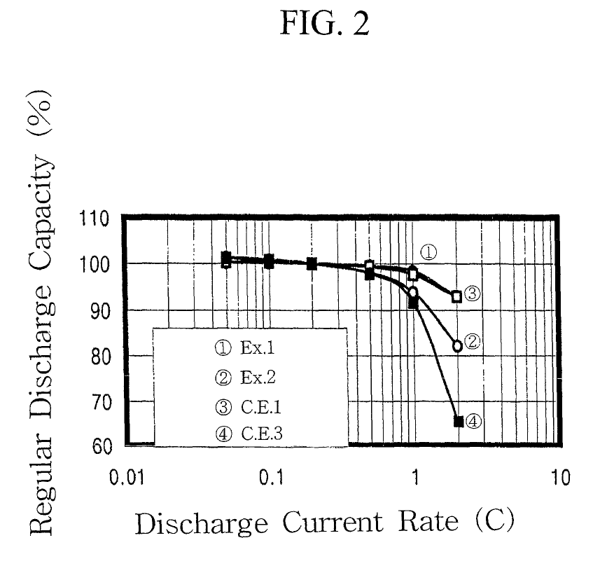

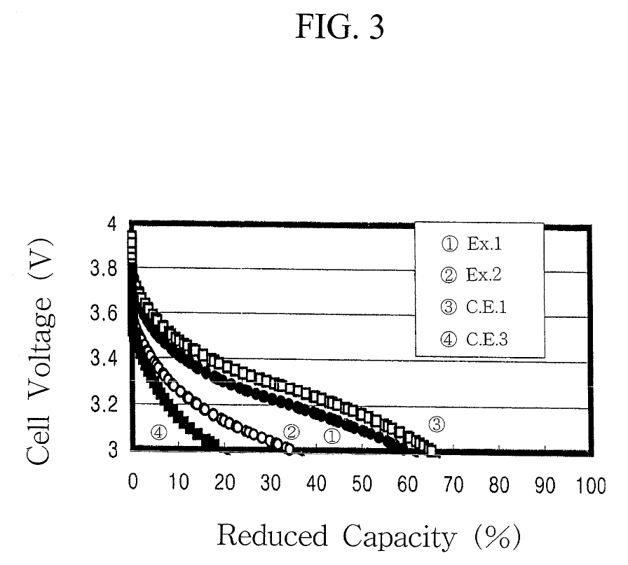

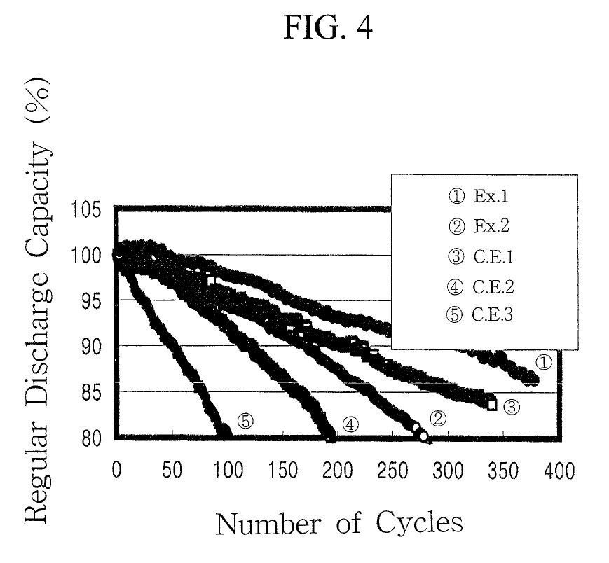

Variations of regular discharge capacity(%) with discharge rate(C), variations of voltage value (at −10° C. and 1C discharge rate) with reduced capacity(%), and variations of regular discharge capacity(%) with cycle number were measured for the batteries obtained in Examples and Comparative Examples, and the results are shown in FIGS. 2, 3 and 4, respectively.

The batteries obtained in Examples 1 and 2 exhibit improved properties, comparable to those of the conventional lithium ion batteries obtained in Comparative Examples 1 and 2, in terms of self-discharge, mean voltage characteristics and cycle life.

Therefore, the present invention provides a simple method for preparing a lithium battery which exhibits improved performance properties and is free from the risk of electrolyte leakage.

While the invention has been described with respect to the above specific embodiments, it should be recognized that various modifications and changes may be made to the invention by those skilled in the art which also fall within the scope of the invention as defined by the appended claims.

What is claimed is

1. A lithium battery comprising a battery case, a liquid electrolyte, a gel-type electrolyte and an electrode stack sealed in the battery case, the stack being made of a cathode, an anode, and a separator interposed between the cathode and the anode, wherein the liquid electrolyte is substantially confined in an inner part of the electrode stack, and the gel-type electrolyte, substantially in an outer part of the electrode stack.

2. The battery of claim 1, wherein the liquid electrolyte comprises an organic solvent and a lithium salt.

3. The battery of claim 1, wherein the gel-type electrolyte comprises an organic solvent, a lithium salt and a polymer.

4. The battery of claim 2 or 3, wherein the lithium salt is selected from the group consisting of LiClO₄, LiBF₄, LiPF₆, LiCF₃SO₃ and LiN(CF₃SO₂)₂.

5. The battery of claim 2 or 3, wherein the organic solvent is selected from the group consisting of propylene carbonate, ethylene carbonate, diethyl carbonate, dimethyl carbonate, ethylmethyl carbonate, dipropyl carbonate, dimethyl sulfoxide, acetonitrile, dimethoxyethane, diethoxyethane, vinylene carbonate, gamma-butyrolactone, ethylene sulfite, propylene sulfite and tetrahydrofuran.

6. The battery of claim 3, wherein the polymer is a polymer obtained by in situ polymerization of an epoxide-based monomer or acryl-based monomer.

7. The battery of claim 6, wherein the in situ polymerization is conducted at a temperature of 30 to 100° C. for 1 to 48 hrs.

8. The battery of claim 3, wherein the polymer is selected from the group consisting of polyvinylidene fluoride, polyethylene oxide, poly(vinylidene fluoride/hexafluoropropylene), polyacrylonitrile, polymethylmethacrylate, polystyrene, polytetrafluoroethylene, an epoxide-based resin and an acryl-based resin.

9. The battery of claim 3, wherein the amount of the polymer is in the range of 6 to 30% by weight based on the gel-type electrolyte.

10. The battery of claim 1, wherein the volume ratio of the liquid and gel-type electrolytes is in the range of 1:0.1˜2.

11. A method of preparing the lithium battery of claim 1, which comprises:
encasing the electrode stack in a case having an inlet; evacuating the case and introducing the liquid electrolyte; introducing the gel-type electrolyte containing a polymer or an in situ polymerizable monomer; optionally conducting in situ polymerization of the monomer; and sealing the inlet.
